(19) United States
(12) Patent Application Publication
(10) Pub. No.: US 2009/0103937 A1
(43) Pub. Date: Apr. 23, 2009

(54) Image Forming Apparatus

(76) Inventor: Tomoo Kudo, Tokyo (JP)

Correspondence Address: Cameron Kerrigan;Squire, Sanders & Dempsey L.L.P., Suite 300, One Maritime Plaza, San Francisco, CA, 94111, US

(21) Appl. No.: 12/031,550

(22) Filed: Feb. 14, 2008

(30) Foreign Application Priority Data
Oct. 17, 2007 (JP) 2007-270240

(51) Int. Cl. G03G 15/00

(52) U.S. Cl. 399/80

(57) ABSTRACT

Disclosed is an image forming apparatus which forms an image on a sheet, including: an image forming section to form an image; a display section to display an operation procedure for maintenance associated with a maintenance object; a first input section to input identification information to identify a user; a storage section to store permission information showing whether or not to allow display of the operation procedure with respect to users and maintenance objects; and a control section to perform a user authentication according to the identification information input in the first input section, to refer to the permission information associated with the authenticated user, and to display the operation procedure permitted to be displayed on the display section.

### BACKGROUND

1. Field of the Invention

The present invention relates to an image forming apparatus.

2. Description of Related Art

Lately, in an image forming apparatus, an ORU (Operator Replacement Unit) enables a user to perform a maintenance operation such as replacing a maintenance object, for example a component or unit, which had been done by servicemen, resulting in reduction of down time of the apparatus. This ORU is realized by for example, training a user for performing an operation procedure for the maintenance of maintenance objects in advance, or displaying the operation procedure on the operation/display section.

As a technique to display the operation procedure, in Japanese Patent Application Laid-Open Publication No. 7-1790, an apparatus is disclosed where when an instruction to perform maintenance such as replacing a component is input by a user, the instruction is notified to the control section, the control section reads out a guide information from a guide storage section showing a replacement operation procedure of the printer component which is the object of replacement, the guide information is output in a text, a drawing, or a voice message, and the procedure of replacing the component is instructed to the user.

However, with such techniques, any unspecified user may display the operation procedure, and maintenance may be performed without careful consideration, and there is a possibility that an injury or accident may be caused by an error during operation, or the maintenance object itself or the apparatus itself may be damaged due to mishandling of the maintenance object.

### SUMMARY

The present invention has been made in consideration of the above problems, and it is one of main objects to prevent damage to a maintenance object or an apparatus due to error during maintenance, to secure safety and to reduce damage.

In order to achieve at least one of the above-described objects, according to a first aspect of the present invention, there is provided an image forming apparatus which forms an image on a sheet, comprising:

an image forming section to form an image;

a display section to display an operation procedure for maintenance associated with a maintenance object;

a first input section to input identification information to identify a user;

a storage section to store permission information showing whether or not to allow display of the operation procedure with respect to users and maintenance objects; and

a control section to perform a user authentication according to the identification information input in the first input section, to refer to the permission information associated with the authenticated user, and to display the operation procedure permitted to be displayed on the display section.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a block diagram showing a control system of an image forming apparatus;

FIG. 2 is a diagram showing an example of a permission information group;

FIG. 3 is a diagram showing an inner structure of an external server;

FIG. 4 is a diagram showing an example of an administrator authentication screen;

FIG. 5 is a diagram showing an example of an administrator menu screen;

FIG. 6 is a diagram showing an example of a user registration screen;

FIG. 7 is a flow chart showing a permission information setting processing;

FIG. 8 is a diagram showing an example of a replacement component/unit permission setting screen;

FIG. 9 is a diagram showing an example of a replacement component/unit permission setting screen;

FIG. 10 is a flow chart showing an operation procedure display processing;

FIG. 11 is a diagram showing an example of a user authentication screen;

FIG. 12 is a diagram showing an example of a user menu screen;

FIG. 13 is a diagram showing an example of a replacement component/unit list screen;

FIG. 14 is a diagram showing an example of an operation procedure screen; and

FIG. 15 is a flow chart showing an alternative example of step S15.

### DETAILED DESCRIPTION OF PREFERRED EMBODIMENTS

A preferred embodiment reflecting an aspect of the present invention will be described in detail with reference to the drawings.

First, the structure will be described.

An image forming apparatus of the present embodiment comprises an image forming section to read an image from an original document or receive image data from an external apparatus, and forms an image on a sheet based on the read image data or received image data. The apparatus may also comprise a post-processing section to perform punching processing, stapling processing, folding processing, cutting processing, etc. to the sheet on which the image is formed.

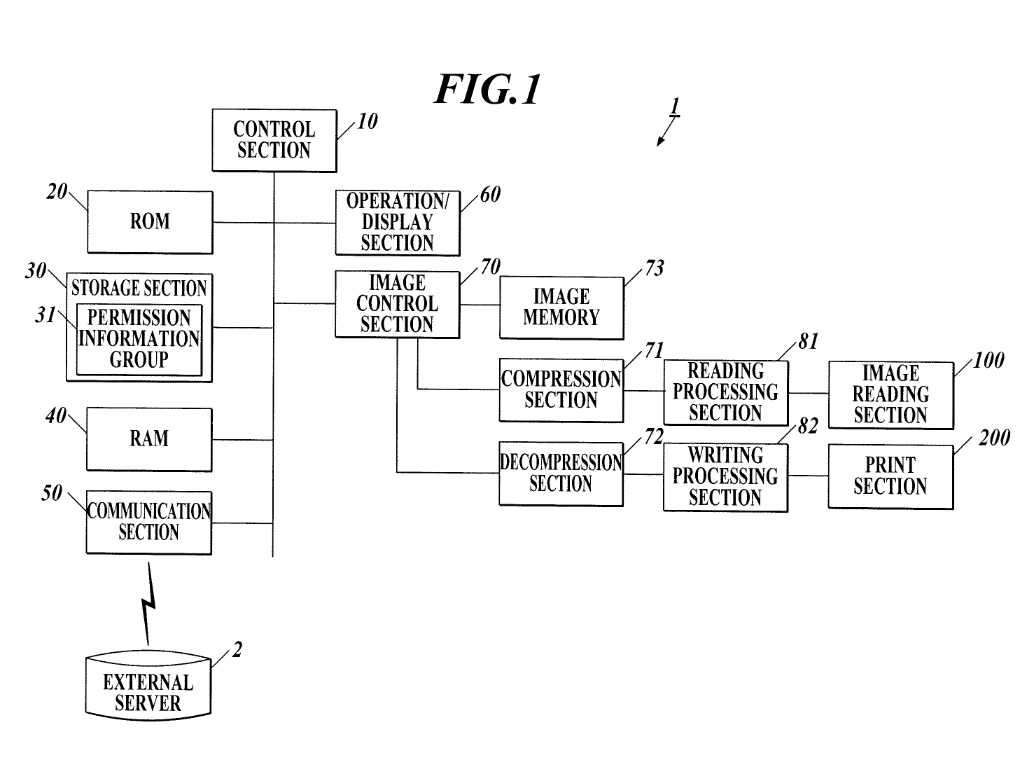

FIG. 1 is a block diagram showing a control system of the image forming apparatus 1 of the present embodiment.

As shown in FIG. 1, the image forming apparatus 1 comprises a control section 10, a ROM 20, a RAM (Random Access Memory) 40, a storage section 30, a communication section 50, an operation/display section 60, an image control section 70, and the like and each section is electrically connected to each other.

The control section 10 comprises a CPU (Central Processing Unit), etc., and centrally controls the operation of each section of the image forming apparatus 1 according to various processing programs stored in the ROM 20. For example, the control section 10 controls switching between copy mode, printer mode and scanner mode; copying; printing; reading of image data; etc., according to an instruction signal input from an external apparatus 2 connected through the operation/display section 60 or the communication section 50.

The control section 10 associates a user name, which shows the user's name as identification information for identifying each user who is input from the operation/display section 60, with a setting of whether or not display of the operation procedure is permitted with respect to maintenance objects and generates permission information. The information is stored in the storage section 30.

When a password and a user name is input from the operation/display section 60, the control section 10 authenticates the user based on the predetermined password and user name for each user, reads out the permission information associated with the authenticated user, and displays on the operation/display section 60 the maintenance operation procedure of the maintenance object permitted to be displayed.

The ROM 20 stores various processing programs and data concerning image forming and also various processing programs such as a user registration processing program, a permission information setting processing program, an operation procedure display processing program, etc. of the present embodiment.

The storage section 30 comprises a nonvolatile memory such as an HDD (Hard Disk Drive) and stores various data such as a user name, a password, etc., a permission information group 31 including a plurality of permission information showing whether or not to allow the display of the operation procedure with respect to users and maintenance objects, display data to display the maintenance operation procedure according to maintenance object, etc.

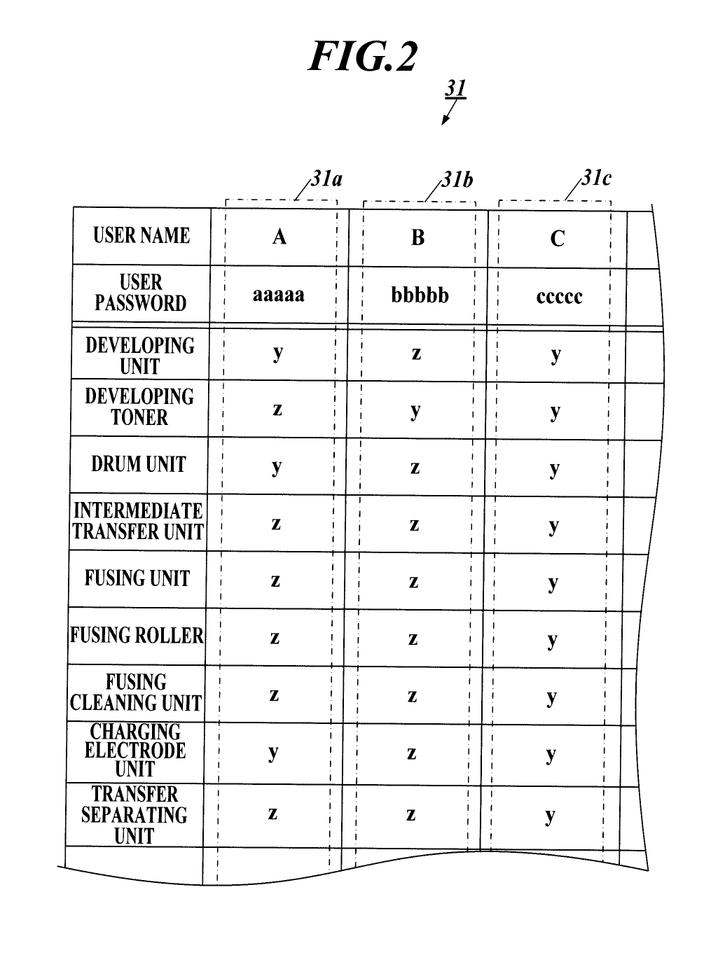

FIG. 2 shows an example of a permission information group 31.

As shown in FIG. 2, the permission information group 31 includes permission information 31a, 31b, 31c and so on set with respect to users.

Each permission information 31a, 31b, 31c and so on includes a user name, a password associated with the user name and information showing whether or not to allow the display of the operation procedure with respect to maintenance objects.

Maintenance objects are various components or units which can be replaced such as a developing unit, developing toner, a drum unit, a transfer unit, a fusing unit, a fusing roller, a fusing cleaning unit, a charging electrode unit, a transfer separating unit, etc. In FIG. 2, for each maintenance object, “y” shows the display of the maintenance operation procedure is set to permit and “z” shows it is set to not permit (prohibit).

The RAM 40 sets a work area for temporarily storing various programs executed by the control section 10 and data, job data, etc., concerning these programs.

The communication section 50 comprises various interface such as, a Network Interface Card (NIC), a MODEM (Modulator-DE Modulator), a USB (Universal Serial Bus), etc., and sends and receives information to and from an external server 2 or an external apparatus (not shown) of a network.

The operation/display section 60 comprises an LCD (Liquid Crystal Display), and a group of operation keys, and a touch panel which covers the LCD is provided. According to a display signal input from the control section 10, the operation/display section 60 displays on the LCD various setting screens for inputting various setting conditions, screens showing various processing results, and various screens displayed when the user registration processing, the permission information setting processing or the operation procedure display processing is performed. The operation/display section 60 outputs an operation signal input with the group of operation keys or the touch panel to the control section 10.

The image control section 70 is connected to the compression section 71, the decompression section 72, the image memory 73, etc., and according to an instruction from the control section 10, controls the compression processing of image data by the compression section 71, the decompression processing of the compressed image data by the decompression section 72 and the input and output of image data from and to the image memory 73.

For example, when the storage of the image data read by the image reading section 100 is instructed, the image control section 70 performs compression processing to the image data input from the reading processing section 81 in the compression section 71 and stores the compressed image data in the compression memory of the image memory 73. When printing output of the compressed image data stored in the compression memory is instructed, the image control section 70 reads out the compressed image data from the compression memory, performs decompression processing in the decompression section 72 and stores the data in the page memory of the image memory 73. When printing output is instructed, the image data is read out from the page memory and output to the writing processing section 82.

The compression section 71 performs compression processing on the input digital image data.

The decompression section 72 performs decompression processing on the input compressed image data.

The image memory 73 comprises a DRAM (Dynamic RAM), a compression memory and a page memory. The compression memory is a memory for storing compressed image data and the page memory is a memory for temporarily storing image data for printing output.

The reading processing section 81 performs various processing such as analog processing, A/D conversion processing, and shading processing, on an analog image signal input from the image reading section 100, then generates digital image data and outputs the generated image data to the compression section 71.

The writing processing section 82 generates print data for the image forming according to the image data input from the image control section 70 and outputs the data to the print section 200.

The image reading section 100 comprises a CCD, an image reading control section, an automatic document feeder section, a reading section, etc. The image reading control section controls the automatic document feeder section, the reading section, etc., and scans the original document face with a light source, performs an optoelectronic conversion with the reflected light on the CCD and thereby reads the image. The read analog image signal is output to the reading processing section 81.

The print section 200 comprises a sheet feeding section, a sheet conveying section, an image forming section, an ejection section, a print control section, etc., and according to the input print data, forms an image with electrophotography.

The sheet feeding section comprises a plurality of sheet feeding trays, a sheet feeding unit, etc. Each sheet feeding tray accommodates sheets sorted beforehand according to size or type. The sheet feeding unit conveys the top sheet one by one to the sheet conveying section.

The sheet conveying section conveys the sheet conveyed from the sheet feeding tray with a plurality of intermediate rollers, registration rollers and the like to the transfer unit. The sheet conveying section uses the conveying path switching board to convey the sheet with an image formed on a single side to the double-side printing conveying path, and then conveys the sheet with the intermediate rollers and registration rollers again to the transfer unit.

The image forming section comprises a drum unit including a photoreceptor drum, a charging electrode unit, a light exposing apparatus including a laser output section for outputting a laser beam according to the image data and a polygon mirror for the laser beam to scan in a main scanning direction, a developing unit including developing toner, a transfer unit, a transfer separating unit, a cleaning section, a fusing unit, etc.

Specifically, an electrostatic latent image is formed by focusing the laser beam with the light exposing apparatus on the photoreceptor drum charged by the charging electrode unit. The developing unit develops the electrostatic latent image formed on the photoreceptor drum with the developing toner and forms the toner image. The toner image on the photoreceptor drum is transferred onto a sheet in the transfer unit. After the toner image is transferred on the sheet, the sheet is separated from the surface of the photoreceptor drum with the transfer separating unit, and the residual toner, etc. on the surface of the photoreceptor drum is removed by the cleaning section.

The fusing unit comprises the fusing roller, the fusing cleaning unit, etc. and heat fuses the toner image transferred onto the sheet with the fusing roller. The fusing cleaning unit cleans a surface of the fusing roller. After the fusing processing is performed on the sheet, the sheet is nipped with a sheet ejection roller of the ejection section and ejected from the ejection opening.

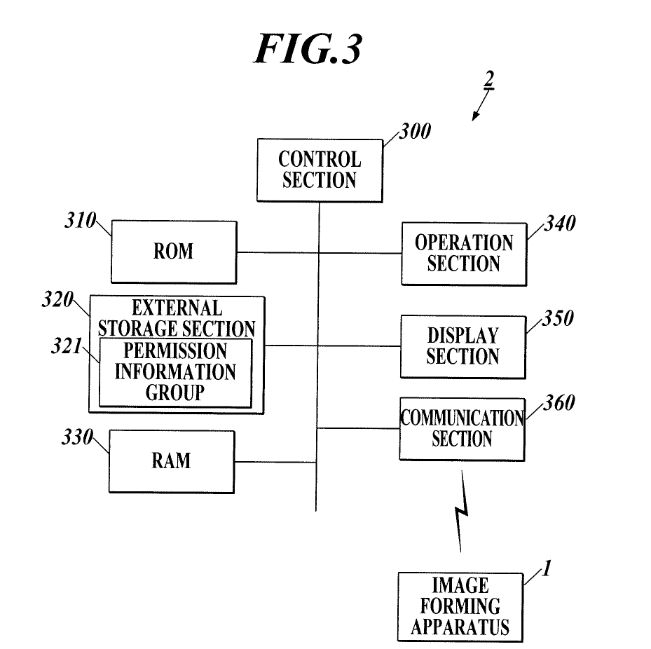

Next, the external server 2 which is an external apparatus connected through the communication section 50 of the image forming apparatus 1 will be described. FIG. 3 is a diagram showing an inner structure of the external server 2.

As shown in FIG. 3, the external server 2 comprises a control section 300, a ROM 310, an external storage section 320 as an external storage section for storing a permission information group 321, a RAM 330, an operation section 340, a display section 350, a communication section 360, etc., and each section is communicably connected to each other.

The control section 300 comprises a CPU, etc., and develops a system program and various control programs stored in the ROM 310 and various data stored in the external storage section 320, etc. in the RAM 330, and centrally controls the general operation of the external server 2. The control section 300 performs various processing according to the programs developed in the RAM 330, then stores the processing result in the RAM 330 and displays the result on the display section 350. The processing result stored in the RAM 330 is stored in the external storage section 320.

According to the identification information (image forming apparatus ID) of the image forming apparatus 1 received from the image forming apparatus 1 and the user name, the control section 300 operates with the program stored in the ROM 310 and the various data such as permission information group 321 stored in the external storage section 320 and retrieves the permission information associated with the user name and sends the retrieved permission information to the image forming apparatus 1.

The ROM 310 stores a system program, various control programs, etc., performed by the control section 300.

The external storage section 320 comprises a nonvolatile memory such as an HDD (Hard Disk Drive) and stores the permission information group 321 set for each image forming apparatus, the data processed by the various programs, etc.

The RAM 330 sets a work area for temporarily storing various programs performed by the control section 300 and the data concerning these programs.

The operation section 340 comprises a keyboard including keys for inputting operation instructions to the external server 2 such as numeric keys, character keys, cursor moving keys, and various function keys, and a pointing device such as a mouse. The operation section 340 outputs to the control section 300 a pushed down signal from the keyboard and an operation signal from the mouse as an input signal.

The display section 350 comprises an LCD, etc. and displays various setting screens on the display screen according to a display signal input from the control section 300.

The communication section 360 comprises various interfaces such as a Network Interface Card (NIC), a MODEM (Modulator-DE Modulator) and a USB (Universal Serial Bus), and sends and receives information to and from the image forming apparatus 1.

Next the operation of the present embodiment will be described.

First, the user registration processing will be described.

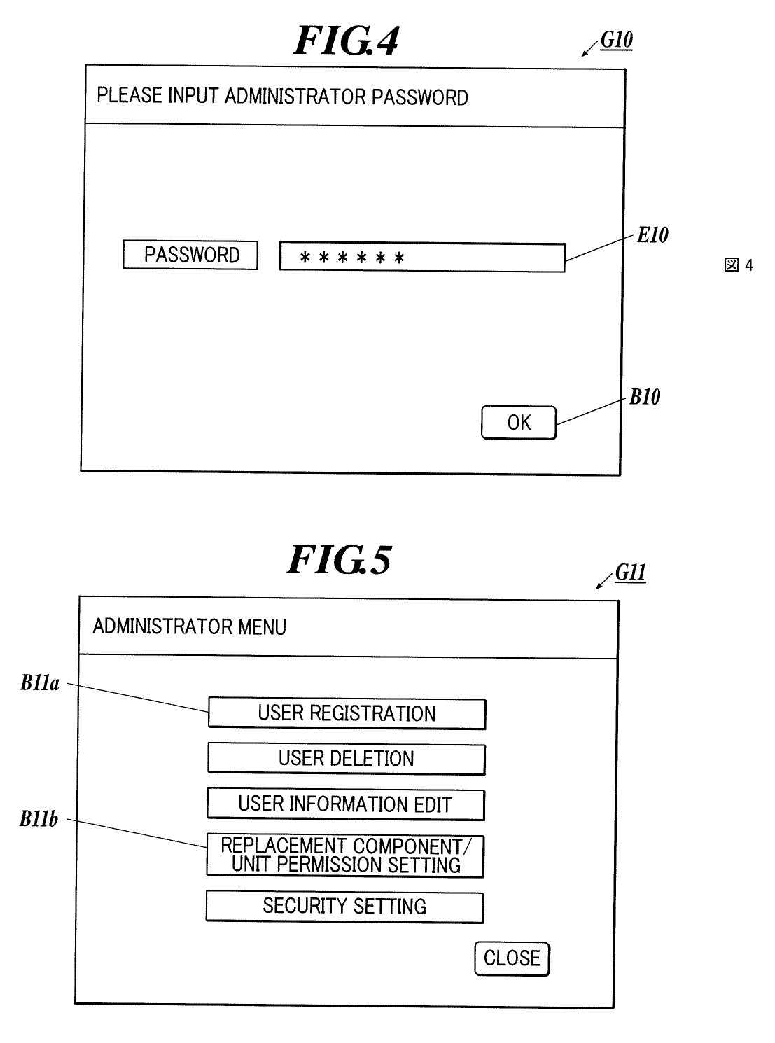

FIGS. 4-6 show examples of various screens displayed on the operation/display section 60 when the user registration processing is performed, and the user registration processing will be described with reference to FIGS. 4-6.

The user registration processing is a processing performed by the control section 10.

FIG. 4 shows an example of an administrator authentication screen G10.

As shown in FIG. 4, the administrator authentication screen G10 includes an administrator password input area E10 for inputting a predetermined administrator password and an OK button B10. When an administrator password is input in the administrator password input area E10 with the operation keys, etc. of the operation/display section 60, and the OK button B10 is pushed down, it is determined whether or not the administrator password corresponds to the administrator. When the password corresponds to the administrator, the administrator menu screen G11 is displayed.

FIG. 5 shows an example of the administrator menu screen G11.

As shown in FIG. 5, the administrator menu screen G11 includes various buttons for displaying various setting screens, for example, a user registration button B11a for displaying a user registration screen G12, a permission setting button B11b for displaying the replacement component/unit permission setting screen, and the like. When this user registration button B11a is pushed down, the user registration screen G12 is displayed.

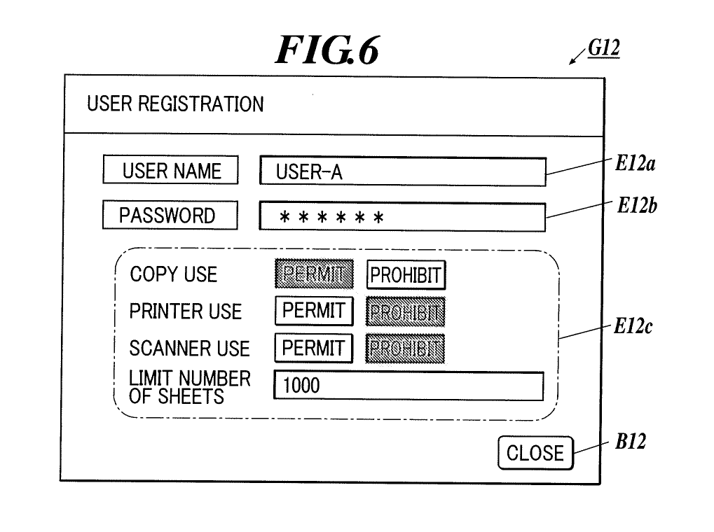

FIG. 6 shows an example of the user registration screen G12.

As shown in FIG. 6, the user registration screen G12 includes a user name input area E12a for inputting the user name, a user password input area E12b for inputting the user password, a function setting area E12c for setting the permission or prohibition of use of the copy function, the printer function, and the scanner function of the image forming apparatus 1 and a maximum number of sheets to be output for the user associated with the user name input in the user name input area E12a, and close button B12. When the close button B12 is pushed down, contents set in the user name input area E12a, the user password input area E12b, and the function setting area E12c are stored associated with each area in the storage section 30 and the user registration processing ends.

Next, the permission information setting processing will be described.

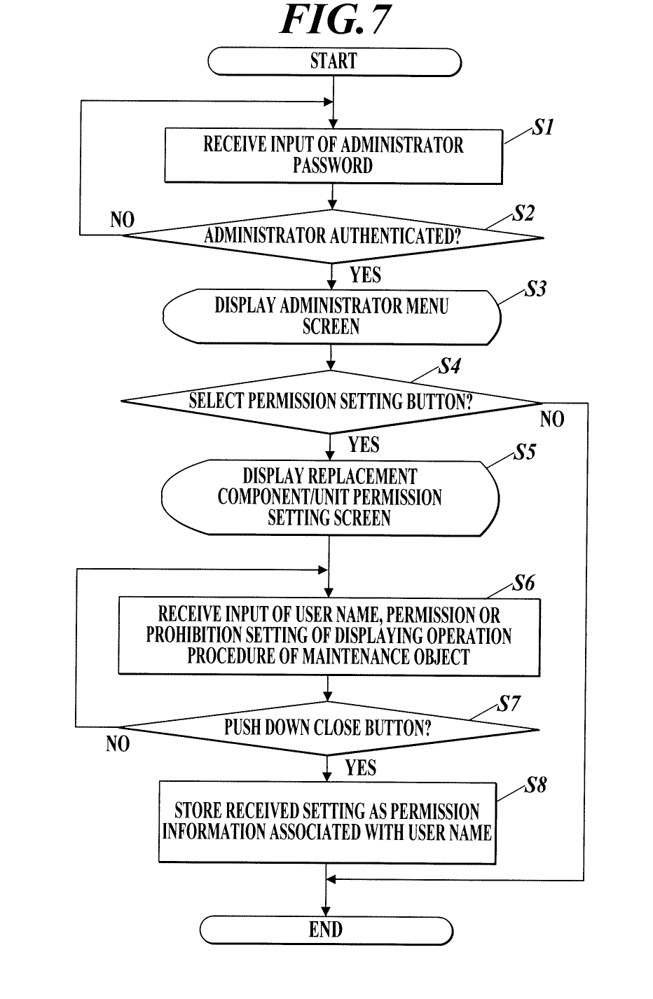

FIG. 7 shows a flow chart of the permission information setting processing and FIGS. 4, 5, 8 and 9 show an example of various screens displayed on the operation/display section 60 when the permission information setting processing is performed. This processing is performed by the control section 10.

The control section 10 performs the authentication processing of the administrator by receiving input of the administrator password on the administrator authentication screen G10 shown in FIG. 4 (step S1), and comparing the input administrator password and the pre-registered administrator password in order to determine whether or not the input administrator password corresponds with the administrator. The control section 10 determines whether or not the input administrator password corresponds with the administrator (whether or not the administrator is authenticated)(step S2), and when the administrator is not authenticated, (step S2; No) returns to step S1.

When the administrator is authenticated (step S2; Yes), the control section 10 displays the administrator menu screen G11 shown in FIG. 5 on the operation/display section 60 (step S3), determines whether or not the permission setting button B11b is selected and pushed down (step S4), and when a button other than the permission setting button B11b is pushed down (step S4; No), the processing ends, and advances to other processing corresponding to the button pushed down.

When the permission setting button B11b is pushed down (step S4; Yes), the control section 10 allows the replacement component/unit permission setting screen to be displayed (step S5).

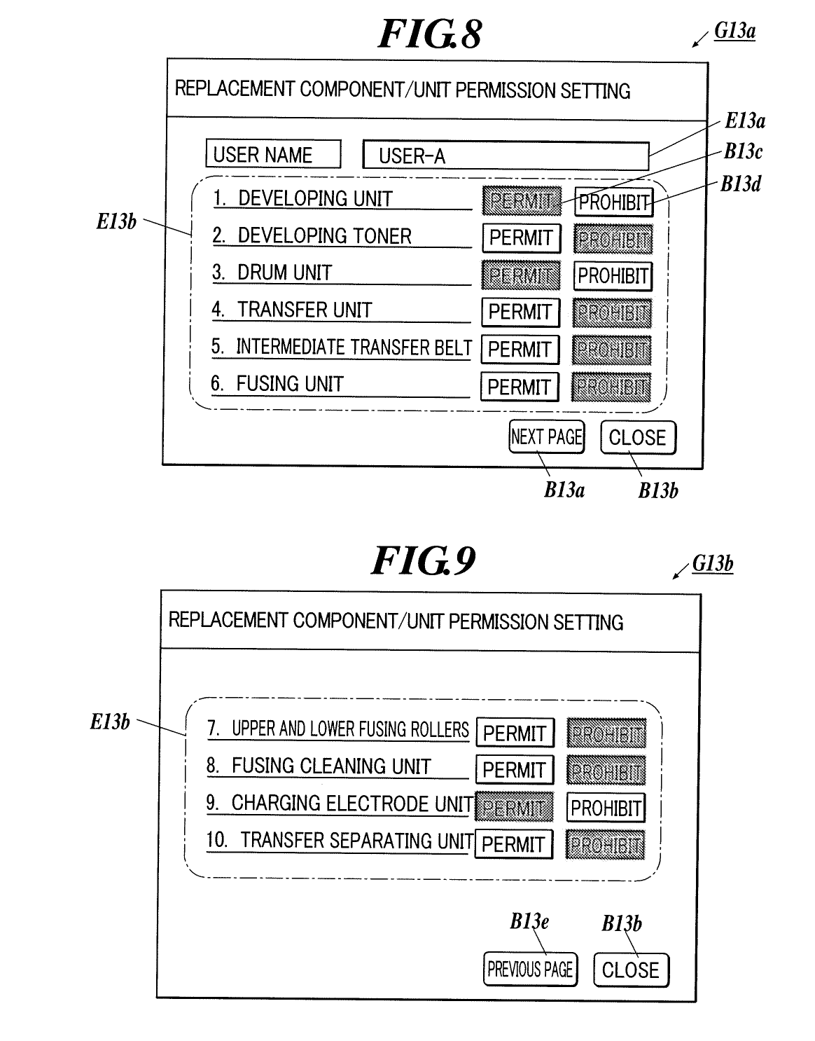

FIGS. 8 and 9 show an example of a replacement component/unit permission setting screen G13a and G13b. The replacement component/unit permission setting screen includes a plurality of screens according to the number of maintenance objects.

As shown in FIG. 8, the replacement component/unit permission setting screen G13a is the first screen displayed when the permission setting button B11b is pushed down, and includes a user name input area E13a which functions as a second input section for receiving an input of the user name, a permission setting area E13b, a next page button B13a for displaying the next replacement component/unit permission setting screen, and a close button B13b for closing the screen. The permission setting area E13b functions as a third input section and includes a button for receiving permission or prohibition setting of the display of the operation procedure with respect to maintenance objects. For example, when the maintenance object is a developing unit, the area includes a permission button B13c for receiving setting which permits the display of the operation procedure of the developing unit and the prohibition button B13d for receiving setting which prohibits the display.

As shown in FIG. 9, the replacement component/unit permission setting screen G13b includes the permission setting area E13b, a previous page button B13e for displaying the previous replacement component/unit permission setting screen, and the close button B13b for closing the screen. The replacement component/unit permission setting screen G13b is a screen displayed when the next page button B13a on the replacement component/unit permission setting screen G13a shown in FIG. 8 is pushed down. When the previous page button B13e of the replacement component/unit permission setting screen G13b is pushed down, the replacement component/unit permission setting screen G13a shown in FIG. 8 is displayed.

On the replacement component/unit screen G13a and G13b, the control section 10 receives input of the user name and the permission or prohibition setting of the display of the operation procedure of each maintenance object (step S6) and determines whether or not the close button B13b is pushed down (step S7) and when the close button B13b is not pushed down (step S7; No), returns to step S6.

When the close button B13b is pushed down (step S7; Yes), the control section 10 associates the permission or prohibition setting of the display of the operation procedure with respect to maintenance objects and the user name received on the replacement component/unit permission setting screen G13a and G13b with the user password corresponding with the user name registered in the user registration processing, and generates permission information. The control section 10 stores the generated permission information in the storage section 30 (step S8) and ends the processing.

Next, the operation procedure display processing will be described.

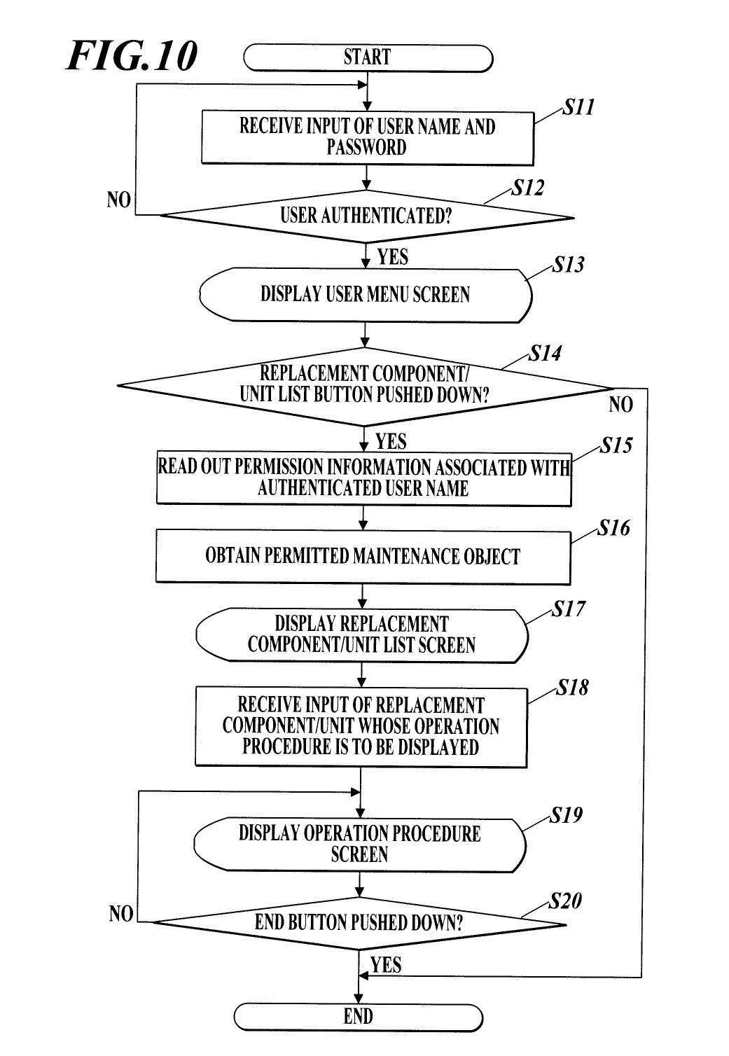

FIG. 10 shows a flow chart of the operation procedure display processing and FIGS. 11-15 show an example of various screens displayed on the operation/display section 60 when the operation procedure display processing is performed. The processing is performed by the control section 10.

The control section 10 displays the user authentication screen on the operation/display section 60.

FIG. 11 shows an example of a user authentication screen G20.

As shown in FIG. 11, the user authentication screen G20 includes a user name input area E20a for receiving input of the user name, a user password input area E20b for receiving input of the user password, and an OK button B20, and functions as a first input section for receiving input of identification information (In the present embodiment the user name and the user password. It is not limited to this information.) which identifies the user.

On the user authentication screen G20 shown in FIG. 11, the control section 10 performs the user authentication processing by receiving input of the user name and the user password (step S11), and determining whether or not the input user name and user password are the registered user name and user password. The control section 10 determines whether or not the input user name and user password correspond to the registered user name and user password (whether the user is authenticated)(step S12) and when the user is not authenticated (step S12; No), returns to step S11.

When the user is authenticated, (step S12; Yes), the control section 10 displays the user menu screen on the operation/display section 60.

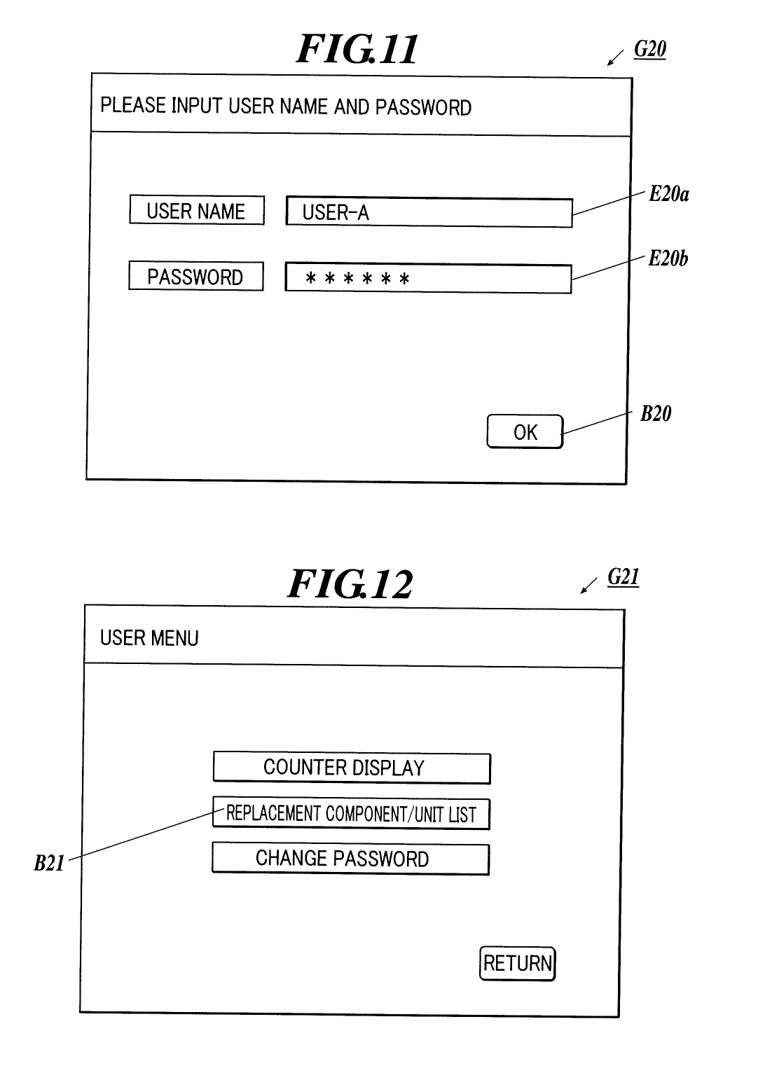

FIG. 12 shows an example of a user menu screen G21.

As shown in FIG. 12, the user menu screen G21 includes various buttons for displaying various setting screens, for example, a replacement component/unit list button B21 for displaying a replacement component/unit list screen.

The control section 10 determines whether or not the replacement component/unit list button B21 is pushed down (step S14), and when a button other than the replacement component/unit list button B21 is pushed down (step S14; No), the processing ends, and advances to another processing according to the button pushed down.

When the replacement component/unit list button B21 is selected and pushed down (step S14; Yes), the control section 10 reads out the permission information associated with the user name of the authenticated user from the permission information group stored in the storage section 30 (step S15), generates the replacement component/unit list screen according to the maintenance object set to permit, which allows the display of the operation procedure, in the read out permission information (step S16), and displays the generated replacement component/unit list screen on the operation/display section 60 (step S17).

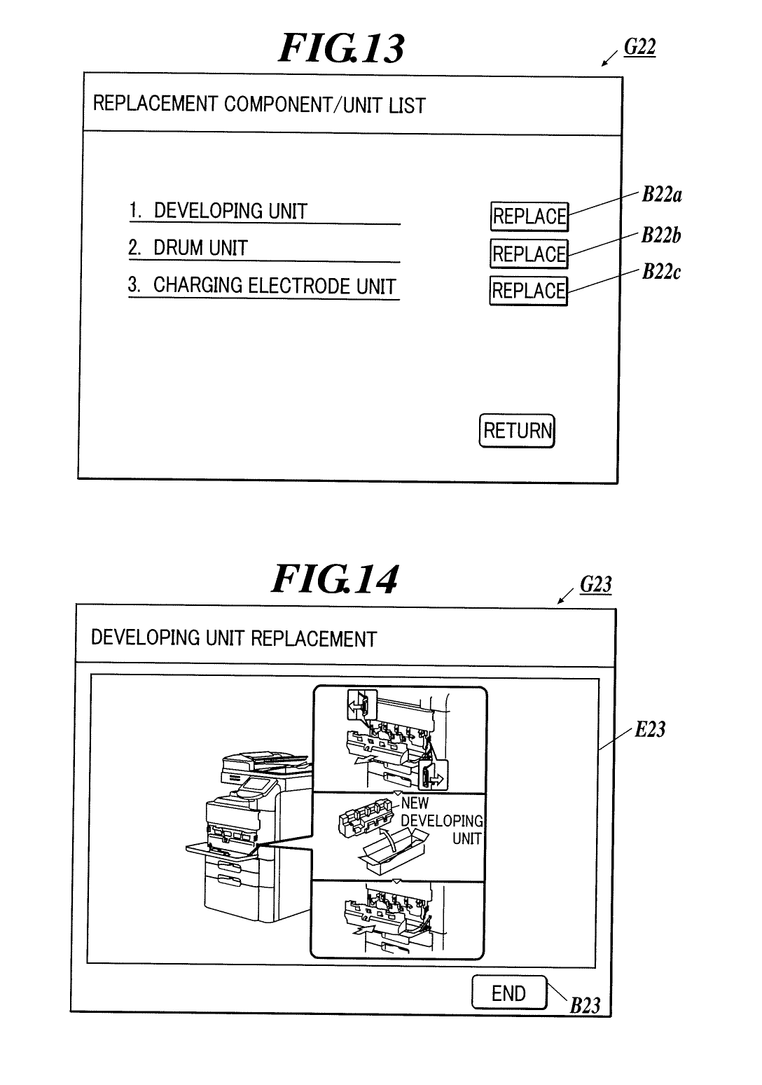

FIG. 13 shows an example of a replacement component/unit list screen G22.

The replacement component/unit list screen G22 shown in FIG. 13 is a screen generated according to the permission information 31a of a user where the user name is A and the user password is aaaaa among the permission information group 31 shown in FIG. 2.

In the permission information 31a shown in FIG. 2, the display of the operation procedure of the developing unit, the drum unit, and the charging electrode unit are set to permit, thus these maintenance objects (the developing unit, the drum unit and the charging electrode unit) set to permit are displayed as items on the replacement component/unit list screen G22. A replacement button for receiving an instruction to display the maintenance operation procedure for performing maintenance such as replacement for each displayed maintenance object is displayed.

As shown in FIG. 13, the replacement component/unit list screen G22 includes a replacement button B22a for receiving an instruction to perform the replacement of the developing unit, a replacement button B22b for receiving an instruction to perform the replacement of the drum unit and a replacement button B22c for receiving an instruction to perform the replacement of the charging electrode unit.

Among the replacement buttons B22a, B22b, and B22c displayed on the replacement component/unit list screen G22, when any one of the replacement buttons is selected and pushed down, the control section 10 determines as receiving an instruction to display the operation procedure associated with the maintenance object of the replacement button pushed down (step S18), and displays on the operation/display section 60 the screen of the operation procedure (operation procedure screen) associated with the maintenance object of the replacement button pushed down (step S19).

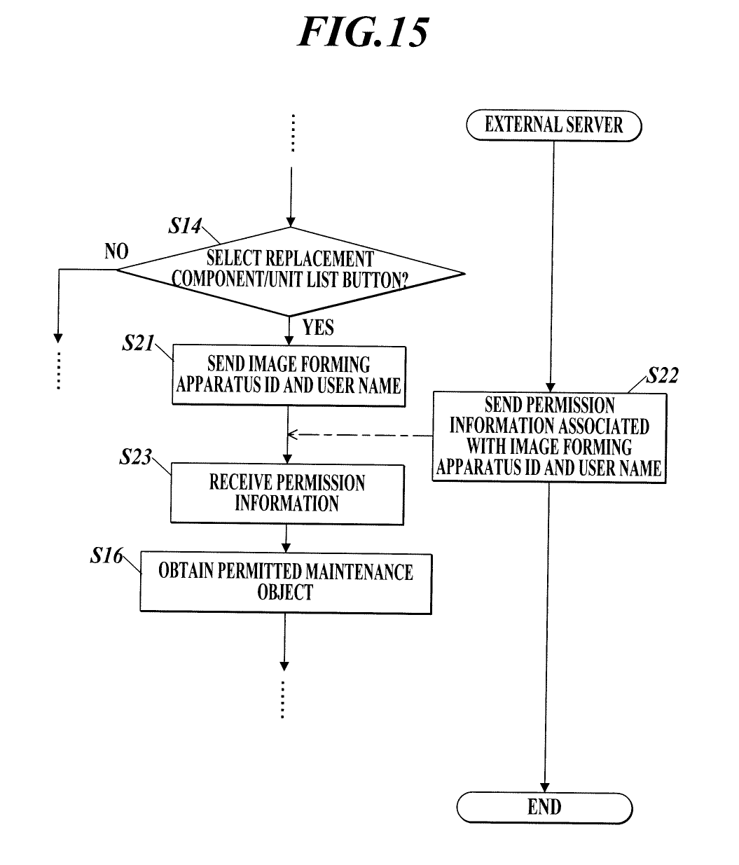

FIG. 14 shows an example of an operation procedure screen.

As shown in FIG. 14, the operation procedure screen G23 includes an operation procedure display area E23 for displaying the operation procedure of the maintenance object corresponding to the replacement button pushed down in step S18 with a drawing or characters and symbols, etc., and an end button B23 for receiving an instruction to end the maintenance operation associated with the maintenance object and an instruction to close the operation procedure screen G23. The user can perform the maintenance according to the operation procedure displayed on the operation procedure screen G23.

When the operation procedure is complicated, etc., a plurality of operation procedure screens may be displayed according to the order of the operation procedure.

The control section 10 determines whether or not the end button B23 of the operation procedure screen G23 is pushed down (step S20) and when the end button B23 is not pushed down (step S20; No), returns to step S19 and when the end button B23 is pushed down (step S20: Yes), the processing ends.

Instead of the step S15 where the display setting information is read out from the storage section 30, the display setting information may be read out from the external server 2.

FIG. 15 shows a flow chart of an example of an alternative to step S15.

When the replacement component/unit list button B21 is pushed down (step S14; Yes), the control section 10 of the image forming apparatus 1 sends the identification information (image forming apparatus ID) pre-set for identifying the image forming apparatus 1 and the user name of the authenticated user through the communication section 50 to the external server 2 (step S21).

The external server 2 receives the image forming apparatus ID and the user name through the communication section 360, reads out the permission information group 321 associated with the image forming apparatus ID from the external storage section 320, reads out the permission information associated with the received user name from the permission information group 321, and sends the read out permission information through the communication section 360 to the image forming apparatus 1 associated with the image forming apparatus ID (step S22).

The control section 10 of the image forming apparatus 1 receives permission information through the communication section 50 (step S23), and generates the replacement component/unit list screen according to the maintenance object which is set to permit in the received permission information (step S16).

Since the operation procedure of the maintenance object which is permitted to be displayed set for each user can be displayed on the LCD of the operation/display section, only the operation procedure of the maintenance object for which each user received training can be displayed. Consequently, maintenance performed without careful consideration by an unspecified user, an injury or accident caused by an error during maintenance operation, and damage of the component or the apparatus itself due to mishandling can be prevented, thus safety can be secured and damage can be reduced.

Since a setting whether or not to allow the display of the operation procedure with respect to maintenance objects can be set for each user associated with the user name, and the permission information can be generated according to the setting and stored, the permission information can be changed appropriately according to the training course of the operation procedure which the user has taken.

Since the permission information can be read out and displayed from an external server, a load of a storage capacity of the storage section 30 of the image forming apparatus can be reduced and when there are a plurality of image forming apparatuses, the permission information for each image forming apparatus and each user can be collectively managed on the external server.

The invention is not limited to the above-described embodiments and may be suitably modified within the scope of the present invention.

According to an aspect of a preferable embodiment, there is provided an image forming apparatus which forms an image on a sheet, comprising:

an image forming section to form an image;

a display section to display an operation procedure for maintenance associated with a maintenance object;

a first input section to input identification information to identify a user;

a storage section to store permission information showing whether or not to allow display of the operation procedure with respect to users and maintenance objects; and

a control section to perform a user authentication according to the identification information input in the first input section, to refer to the permission information associated with the authenticated user, and to display the operation procedure permitted to be displayed on the display section.

According to the above-described image forming apparatus, since the operation procedure of the maintenance object which is permitted to be displayed set for each user can be displayed on the display section, only the operation procedure of the maintenance object for which each user received training can be displayed on the display section. Consequently, maintenance performed without careful consideration by an unspecified user, an injury or accident caused by an error during maintenance operation, and damage of the component or the apparatus itself due to mishandling can be prevented, thus safety can be secured and damage can be reduced.

Preferably, the image forming apparatus further comprises,

a second input section to input the identification information; and

a third input section to input a setting of whether or not to allow the display of the operation procedure with respect to the maintenance objects, wherein

the control section associates the identification information input in the second input section with the setting input in the third input section and stores in the storage section the setting as the permission information of the user associated with the identification information.

According to the above-described image forming apparatus, since a setting whether or not to allow the display of the operation procedure with respect to maintenance objects can be set for each user associated with the identification information, and the permission information can be generated according to the setting and stored, the permission information can be changed appropriately according to the training course of the operation procedure which the user has taken.

Preferably, the image forming apparatus further comprises a communication section to communicate with an external device which includes an external storage section for storing the permission information, wherein

the control section reads out the permission information associated with the identification information of the authenticated user from the external storage section and displays the operation procedure permitted to be displayed on the display section according to the read out permission information.

According to the above-described apparatus, since the permission information can be read out and displayed from an external device which includes an external storage section, a load of a storage capacity of the storage section of the image forming apparatus can be reduced and when there are a plurality of image forming apparatuses, the permission information for each image forming apparatus and each user can be collectively managed.

The present U.S. Patent Application claims priority under the Paris Convention of Japanese Patent Application No. 2007-270240 filed on Oct. 17, 2007 to the Japanese Patent Office, which shall be a basis for correcting mistranslations.

What is claimed is:

1. An image forming apparatus which forms an image on a sheet, comprising:
an image forming section to form an image;
a display section to display an operation procedure for maintenance associated with a maintenance object;
a first input section to input identification information to identify a user;
a storage section to store permission information showing whether or not to allow display of the operation procedure with respect to users and maintenance objects; and
a control section to perform a user authentication according to the identification information input in the first input section, to refer to the permission information associated with the authenticated user, and to display the operation procedure permitted to be displayed on the display section.

2. The image forming apparatus of claim 1, further comprising,
a second input section to input the identification information; and
a third input section to input a setting of whether or not to allow the display of the operation procedure with respect to the maintenance objects, wherein
the control section associates the identification information input in the second input section with the setting input in the third input section and stores in the storage section the setting as the permission information of the user associated with the identification information.

3. The image forming apparatus of claim 1, further comprising a communication section to communicate with an external device which includes an external storage section for storing the permission information, wherein
the control section reads out the permission information associated with the identification information of the authenticated user from the external storage section and displays the operation procedure permitted to be displayed on the display section according to the read out permission information.
